(19) United States
(12) Patent Application Publication
(10) Pub. No.: US 2022/0221180 A1
(43) Pub. Date: Jul. 14, 2022

(54) CONTROL SYSTEM

(71) Applicant: DAIKIN INDUSTRIES, LTD., Osaka-shi (JP)

(72) Inventors: Tomoharu ASHIZAWA, Osaka-shi (JP); Takahiro NAKATA, Osaka-shi (JP); Kouhei OGAWA, Osaka-shi (JP); Naveen GUNTURU, Osaka-shi (JP); Kanami HARADA, Osaka-shi (JP)

(73) Assignee: DAIKIN INDUSTRIES, LTD., Osaka-shi (JP)

(21) Appl. No.: 17/707,664

(22) Filed: Mar. 29, 2022

Related U.S. Application Data
(63) Continuation of application No. PCT/JP2020/036088, filed on Sep. 24, 2020.

(30) Foreign Application Priority Data
Sep. 30, 2019 (JP) 2019-180833

(51) Int. Cl. F24F 11/56; G06F 3/01; F24F 11/46

(52) U.S. Cl. CPC F24F 11/56; F24F 2120/20; F24F 11/46; G06F 3/01

(57) ABSTRACT

A control system controls an air conditioner that air-conditions an air conditioning target area using a detection value of a biometric sensor worn by a user, the control system includes a processor that performs a first acquisition that acquires first information related to a distance between a reference point of the air conditioning target area and the biometric sensor, a first determination that determines whether to use a detection value of the biometric sensor for controlling the air conditioner based on the first information and a determination criterion, and a second determination that determines the determination criterion.

### CROSS REFERENCE TO RELATED APPLICATIONS

This application is a Continuation of PCT International Application No. PCT/JP2020/036088, filed on Sep. 24, 2020, which claims priority under 35 U.S.C. 119(a) to Patent Application No. 2019-180833, filed in Japan on Sep. 30, 2019, all of which are hereby expressly incorporated by reference into the present application.

### TECHNICAL FIELD

The present invention relates to a control system.

### BACKGROUND ART

Conventionally, a control device controls operation of an air conditioner based on air conditioning operation information associated with a terminal having a highest priority among terminals determined to exist within an effective range (Patent Literature 1 (Japanese Unexamined Patent Publication No. JP 2017-150702 A)).

### SUMMARY

A control system according to a first aspect is a control system that controls an air conditioner that air-conditions an air conditioning target area using a detection value of a biometric sensor worn by a user. The control system according to the first aspect includes a first acquisition part, a first determination part, and a second determination part. The first acquisition part acquires first information related to a distance between a reference point of an air conditioning target area and the biometric sensor. The first determination part determines whether to use the detection value of the biometric sensor for controlling the air conditioner based on the first information and a determination criterion. The second determination part determines the determination criterion.

### BRIEF DESCRIPTION OF THE DRAWINGS

FIG. 1 is a conceptual diagram of an air conditioning target area.

FIG. 2 is a functional block diagram of a control system.

FIG. 3 is a flowchart of the control system.

FIGS. 4A and 4B are examples of the air conditioning target area.

FIGS. 5A and 5B are examples of control of an air conditioner.

FIG. 6 is a functional block diagram of the control system.

FIG. 7A is a flowchart of the control system.

FIG. 7B is a flowchart of the control system.

### DESCRIPTION OF EMBODIMENTS

### First Embodiment

(1) Overall Configuration

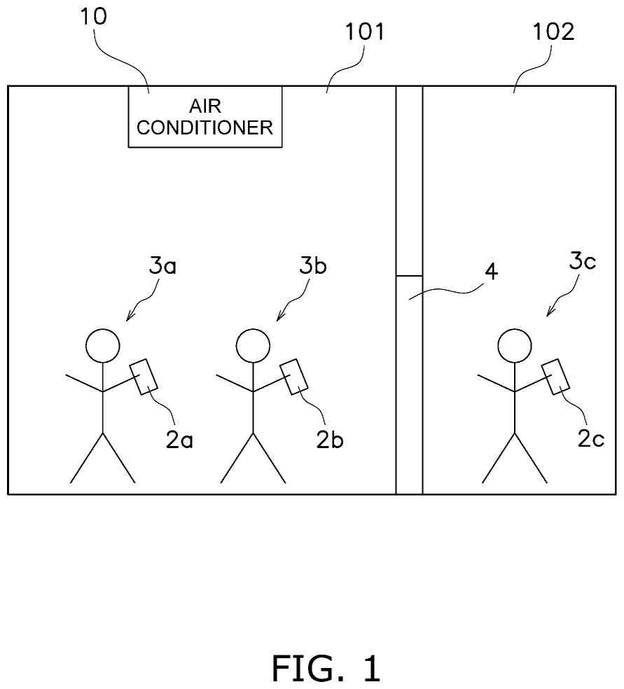

FIG. 1 is a conceptual diagram of an air conditioning target area 101. The air conditioning target area 101 is a space including an air conditioner 10. A user 3a wearing a biometric sensor 2a and a user 3b wearing a biometric sensor 2b are present in the air conditioning target area 101. The air conditioner 10 is controlled using detection values of the biometric sensors 2a and 2b worn by the users 3a and 3b, respectively, being present in the air conditioning target area 101.

A space 102 is separated from the air conditioning target area 101 by a door 4 and is outside the air conditioning target area 101 of the air conditioner 10. A user 3c having a biometric sensor 2c is present in the space 102. A detection value of the biometric sensor 2c worn by the user 3c being present in the space 102 is not used for controlling the air conditioner 10.

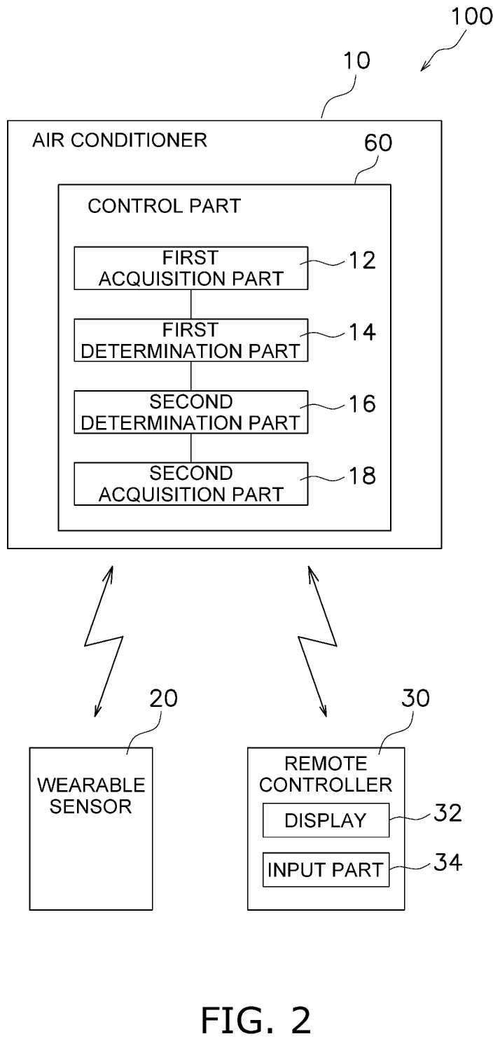

FIG. 2 illustrates a control system 100 according to the present embodiment. The control system 100 includes the air conditioner 10, a wearable sensor (biometric sensor) 20, and a remote controller 30.

The control system 100 according to the present embodiment controls the air conditioner 10 that air-conditions the air conditioning target area 101 using a detection value of the wearable sensor 20 worn by the user. The user uses the remote controller 30 to input information related to a size of the air conditioning target area 101 in which the air conditioner 10 is installed or the like.

(2) Detailed Configuration

(2-1) Air Conditioner 10

The air conditioner 10 is an air conditioner having functions of cooling, heating, dehumidifying, and humidifying. The air conditioner 10 controls the air conditioning target area 101 using the detection value of the wearable sensor 20 worn by the user.

The air conditioner 10 includes a control unit 60.

(2-1-1) Control Unit 60

The control unit 60 is achieved by a computer. The control unit 60 includes a control calculation unit and a storage unit. The control calculation unit may be a processor such as a CPU or a GPU. The control calculation unit reads a program stored in the storage unit and executes predetermined image processing or calculation processing in accordance with the program. The control calculation unit can write a calculation result to the storage unit and read information stored in the storage unit in accordance with the program. FIG. 2 illustrates various function blocks achieved by the control calculation unit. The storage unit can be used as database.

The control unit 60 includes a first acquisition part 12, a first determination part 14, a second determination part 16, and a second acquisition part 18.

The first acquisition part 12 acquires radio wave intensity between the air conditioner 10 and the wearable sensor 20 as first information. The first information is a parameter related to a distance between a reference point of the air conditioning target area 101 and the wearable sensor 20.

The first determination part 14 determines whether the wearable sensor 20 is located in the air conditioning target area 101 based on the first information and a determination criterion. The first determination part 14 determines whether to use the detection value of the wearable sensor 20 for controlling the air conditioner 10 based on the first information as radio wave information between the reference point of the air conditioning target area 101 and the wearable sensor 20 and the determination criterion.

The second determination part 16 determines a determination criterion based on information from the second acquisition part 18. Here, the determination criterion is a threshold value related to the first information.

The second acquisition part 18 acquires information manually input by the user using the remote controller 30. In the control system 100, the manually input information is information related to the size of the air conditioning target area 101 in which the air conditioner 10 is installed.

(2-2) Biometric Sensor 20

In the control system 100 according to the present embodiment, the biometric sensor 20 is a wearable sensor. The air conditioner 10 receives a radio wave from the wearable sensor 20 worn by the user.

(2-3) Remote Controller 30

The remote controller 30 is a remote controller of the air conditioner 10. The remote controller 30 bidirectionally communicates with the air conditioner 10. The remote controller 30 includes a display 32 and an input part 34.

The display 32 displays options for allowing the user to manually input the information related to the size of the air conditioning target area 101.

The input part 34 allows the user to manually input the information related to the size of the air conditioning target area 101.

(3) Overall Operation

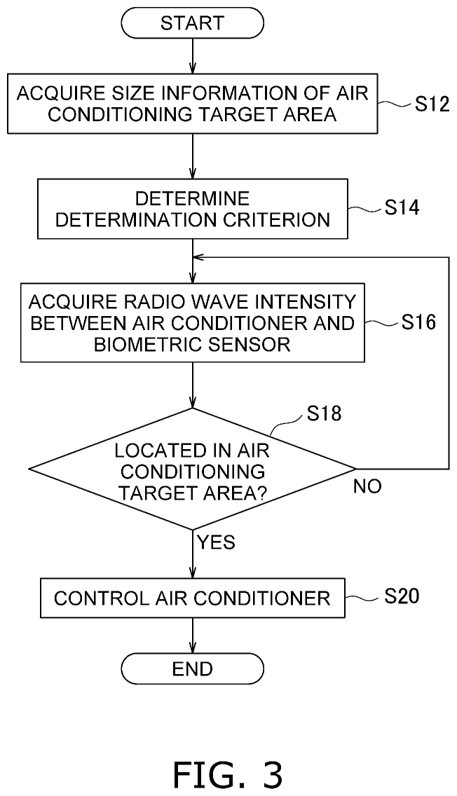

FIG. 3 is a flowchart of the control system 100.

First, in step S12, the second acquisition part 18 acquires the information related to the size of the air conditioning target area 101 manually input from the input part 34 of the remote controller 30.

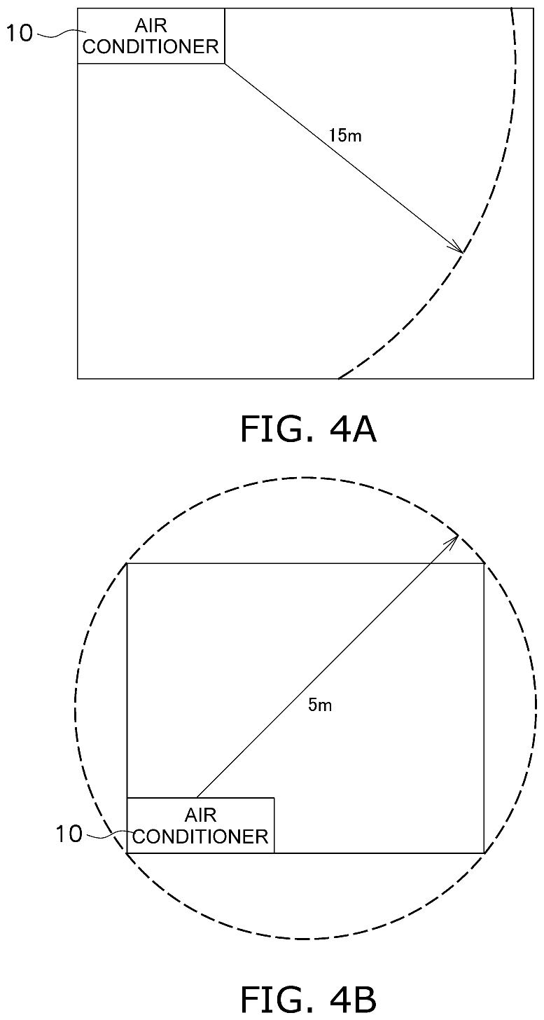

FIG. 4 is an example of the air conditioning target area 101. Upon determination of a reachable range of the air conditioner 10 in the air conditioning target area 101, options such as a large room and a small room are prepared in advance and manually selected by the user. For example, as illustrated in FIG. 4(a), an area included in a range of a radius of 15 m from an installation location of the air conditioner 10 is set as a large room, and as illustrated in FIG. 4(b), an area included in a range of a diameter of 5 m from the installation location of the air conditioner 10 is set as a small room. Options related to a size of the room (the size of the air conditioning target area 101) are displayed on the display 32 of the remote controller 30. The user uses the input part 34 of the remote controller 30 to select the size of the air conditioning target area 101 from the options displayed on the display 32.

The second determination part 16 determines a determination criterion based on the information related to the size of the air conditioning target area 101 (step S14).

The first acquisition part 12 acquires the radio wave intensity between the air conditioner 10 and the wearable sensor 20 as the first information (step S16).

Next, in step S18, based on the first information acquired in step 16 and the determination criterion determined in step S14, the first determination part 14 determines whether the wearable sensor 20 is located in the air conditioning target area 101.

When the first determination part 14 estimates that the wearable sensor 20 is located in the air conditioning target area 101 (Yes in step S18), the air conditioner 10 is controlled using the detection value of the wearable sensor 20 (step S20).

When the first determination part 14 estimates that the wearable sensor 20 is not located in the air conditioning target area 101 (No in step S18), the processing returns to step S16.

Next, a case where a plurality of users are present in the air conditioning target area 101 will be described.

Upon determination of whether to use the detection values of the wearable sensors 20 worn by the plurality of users for controlling the air conditioner 10, the first determination part 14 determines that the detection values of the wearable sensors 20 worn by the plurality of users are not used for controlling the air conditioner 10 when all the users move and positions of the wearable sensors 20 worn by the plurality of users are changed from an inside of the air conditioning target area 101 to an outside of the air conditioning target area 101. After the positions of all the wearable sensors 20 connected to the air conditioner 10 are changed from an inside of the air conditioning target area 101 to an outside of the air conditioning target area 101 by the movement of the plurality of users, the operation of the air conditioner 10 is stopped or suppressed.

(4) Characteristics

(4-1)

The control system 100 according to the present embodiment is a control system that controls the air conditioner 10 that air-conditions the air conditioning target area 101 using the detection value of the wearable sensor 20 worn by the user. The control system 100 according to the present embodiment includes the first acquisition part 12, the first determination part 14, and the second determination part 16. The first acquisition part 12 acquires the first information related to the distance between the reference point of the air conditioning target area 101 and the wearable sensor 20. The first determination part 14 determines whether to use the detection value of the wearable sensor 20 for controlling the air conditioner 10 based on the first information and the determination criterion. The second determination part 16 determines the determination criterion.

In the control system 100, the air-conditioning control is more appropriately performed when the detection value of the wearable sensor 20 worn by the user is used for controlling the air conditioner 10. In the control system 100, by determining the determination criterion for determining whether to use the detection value of the wearable sensor 20 worn by the user for the air conditioning control, the air conditioner 10 can be controlled using biometric information of the user regardless of the size of the air conditioning target area 101.

(4-2)

In the control system 100 according to the present embodiment, the first determination part 14 determines whether the wearable sensor 20 is located in the air conditioning target area 101 based on the first information and the determination criterion.

In the control system 100, when the wearable sensor 20 is located in the air conditioning target area 101, the detection value of the wearable sensor 20 can be used for controlling the air conditioner 10.

(4-3)

In the control system 100 according to the present embodiment, the first acquisition part 12 acquires the radio wave intensity between the air conditioner 10 and the wearable sensor 20 as the first information.

In the control system 100, the radio wave intensity can be used for determining whether to use the detection value of the wearable sensor 20 for controlling the air conditioner 10.

(4-4)

The control system 100 according to the present embodiment further includes the second acquisition part 18 that acquires manually input information. The manually input information includes at least one of the information related to the size of the air conditioning target area 101 or the information related to the distance from the reference point of the air conditioning target area 101, and the second determination part 16 determines the determination criterion based on the information from the second acquisition part 18.

In the control system 100, initial setting of control of the air conditioner 10 can be performed by manually inputting information.

(4-5)

The control system 100 according to the present embodiment further includes an automatic measurement part that automatically measures the size or the shape of the air conditioning target area 101, and the second determination part 16 determines the determination criterion based on a measurement result by the automatic measurement part.

In this control system, the size or the shape of the air conditioning target area 101 can be automatically measured to determine the determination criterion.

(4-6)

In the control system 100 according to the present embodiment, upon determination of whether to use the detection values of the wearable sensors 20 worn by the plurality of users for controlling the air conditioner 10, the first determination part 14 determines that the detection values of the wearable sensors 20 are not used for controlling the air conditioner 10 when the positions of the wearable sensors 20 are changed from an inside of the air conditioning target area 101 to an outside of the air conditioning target area 101.

In the control system 100, the air-conditioning control is more appropriately performed when the detection values of the wearable sensors 20 worn by the plurality of users are used for controlling the air conditioner 10.

(4-7)

In the control system 100 according to the present embodiment, after the positions of all the biometric sensors connected to the air conditioner 10 are changed from an inside of the air conditioning target area 101 to an outside of the air conditioning target area 101, the operation of the air conditioner 10 is stopped or suppressed.

In the control system 100, energy can be saved by stopping or suppressing the operation of the air conditioner 10.

(4-8)

In the control system 100 according to the present embodiment, the air conditioner 10 and the wearable sensor 20 keep connected to each other when the position of the wearable sensor 20 is changed from an inside of the air conditioning target area 101 to an outside of the air conditioning target area 101.

In the control system 100, even when the user wearing the wearable sensor 20 temporarily moves out of the air conditioning target area 101 and then returns into the air conditioning target area 101, the detection value of the wearable sensor 20 can be promptly used.

(4-9)

In the control system 100 according to the present embodiment, when the detection value of the wearable sensor 20 is used in the air conditioning target area 101, the control of the air conditioner 10 is further changed in accordance with the distance.

In the control system 100, when the positions of some of the plurality of wearable sensors are far from the reference point of the air conditioner, the weighting of the detection values of the wearable sensors far from the reference point is reduced, the weighting of the detection values of the wearable sensors close to the reference point is increased, and the detection values of the wearable sensors can be used for controlling the air conditioner.

(5) Modifications

(5-1) Modification 1A

In the control system 100 according to the present embodiment, upon determination of the reachable range of the air conditioner 10 in the air conditioning target area 101, the options such as a large room and a small room are prepared in advance and are manually selected by the user. However, the present invention is not limited to this description. Upon determination of the reachable range of the air conditioner 10 in the air conditioning target area 101, for example, assuming that a room is simply a quadrangle, the user may manually input lengths of four sides of the room, and an installation company may select a position of the air conditioner such as a center, a left corner, or a right corner of a wall. The reachable range of the air conditioner in the air conditioning target area may be defined in association with communication intensity by bordering the room with a smartphone or the wearable sensor held by the user.

(5-2) Modification 1B

In the control system 100 according to the present embodiment, upon determination of the reachable range of the air conditioner 10 in the air conditioning target area 101, the options such as a large room and a small room are prepared in advance and are manually selected by the user in the above description. Alternatively, the control system 100 may further include the automatic measurement part that automatically measures the size or the shape of the air conditioning target area 101. For example, the air conditioner 10 may include a radar sensor, and the shape of the air conditioning target area 101 may be detected using the radar sensor. The size or the shape of the air conditioning target area 101 may be detected by simultaneous localization and mapping (SLAM) by running a mobile unit into the air conditioning target area 101. The reachable range of the air conditioner 10 in the air conditioning target area 101 may be defined from the detection result as to whether the user is in the air conditioning target area 101 and Bluetooth (registered trademark) communication intensity at a boundary between an area where the user is present and an area where the user is not present. The reachable range of the air conditioner 10 in the air conditioning target area 101 may be defined by image analysis using an optical sensor. The size of the air conditioning target area 101 estimated from a capability class of the air conditioner 10 and a rate of change in temperature in the air conditioning target area 101 may be assumed to be the reachable range of the air conditioner 10 in the air conditioning target area 101.

(5-3) Modification 1C

In the control system 100 according to the present embodiment, when the wearable sensor 20 is located in the air conditioning target area 101, the detection value of the wearable sensor 20 is used for controlling the air conditioner 10 in the above description. When the position of the wearable sensor 20 is changed from an inside of the air conditioning target area 101 to an outside of the air conditioning target area 101, the air conditioner 10 and the wearable sensor 20 may keep connected to each other.

(5-4) Modification 1D

In the control system 100 according to the present embodiment, the detection value of the biometric sensor 20 is used for controlling the air conditioner 10 when the biometric sensor (wearable sensor) 20 is in the air conditioning target area 101 in the above description. When the detection value of the biometric sensor 20 is used in the air conditioning target area 101, the control of the air conditioner 10 may be further changed in accordance with the distance.

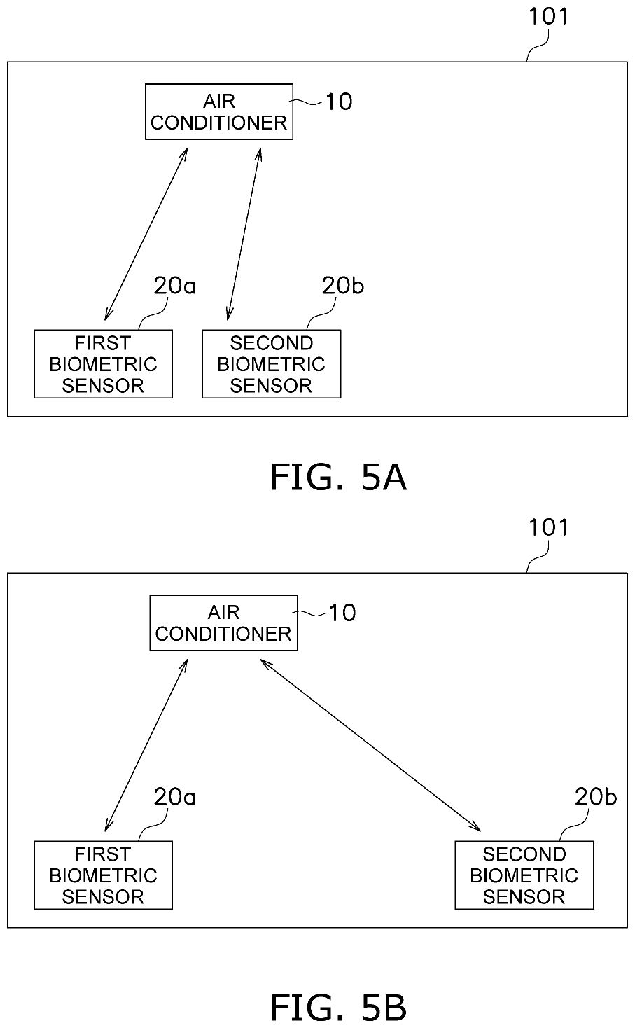

As illustrated in FIG. 5(a), when the first biometric sensor 20a and the second biometric sensor 20b are located close to the air conditioner, the detection values of both the first biometric sensor 20a and the second biometric sensor 20b are used for controlling the air conditioner 10 with the same weighting. For example, when the detection value of the first biometric sensor 20a is 25 degrees and the detection value of the second biometric sensor 20b is 27 degrees, the air conditioner 10 is controlled to 26 degrees.

As illustrated in FIG. 5(b), when the first biometric sensor 20a is located close to the air conditioner 10 but the second biometric sensor 20b is located away from the air conditioner 10, the weighting of the detection value of the first biometric sensor 20a is increased, the weighting of the detection value of the second biometric sensor 20b is decreased, and the detection values of the first biometric sensor 20a and the second biometric sensor 20b are used for controlling the air conditioner 10. In this case, the weighting of 25 degrees of the detection value of the first biometric sensor 20a is increased, and the weighting of 27 degrees of the detection value of second biometric sensor 20b is decreased, and thus the air conditioner is controlled to 25.5 degrees.

(5-5) Modification 1E

In the control system 100 according to the present embodiment, the air conditioner 10 directly receives the radio wave from the wearable sensor 20 in the above description. Alternatively, the air conditioner 10 may receive the radio wave from the wearable sensor 20 via a relay device.

### Second Embodiment

(1) Overall Configuration

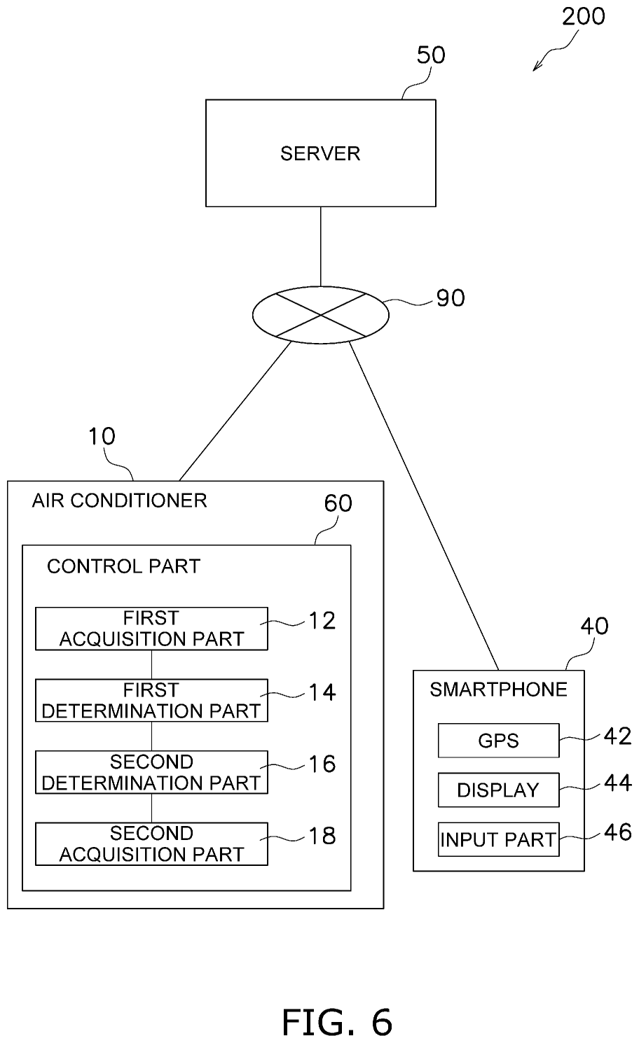

As shown in FIG. 6, a control system 200 according to the present embodiment includes the air conditioner 10, a biometric sensor 40, and a server 50. The air conditioner 10 is connected to the server 50 via a network 90. The smartphone (biometric sensor) 40 communicates with the server 50.

(2) Detailed Configuration

(2-1) Air Conditioner 10

The air conditioner 10 is an air conditioner having functions of cooling, heating, dehumidifying, and humidifying. The air conditioner 10 according to the present embodiment air-conditions the air conditioning target area 101 using a detection value of the biometric sensor 40 worn by the user.

The air conditioner 10 includes a control unit 60. Note that, in the control system 200 according to the present embodiment, the configuration of the control unit 60 is basically the same as the configuration of the control system 100, and thus a detailed description thereof will be omitted.

(2-2) Biometric Sensor 40

In the control system 200 according to the present embodiment, the biometric sensor 40 is a smartphone. The smartphone 40 includes a GPS 42, a display 44, and an input part 46.

The display 44 displays options for allowing the user to manually input the information related to the size of the air conditioning target area 101.

The input part 46 allows the user to manually input the information related to the size of the air conditioning target area 101.

The smartphone 40 communicates with the server 50 to transmit the information input from the input part 46 of the smartphone 40 to the air conditioner 10. The air conditioner 10 communicates with the server 50 via the network 90. The smartphone 40 communicating with the server 50 displays the information and the like transmitted from the air conditioner 10 on the display 44.

(3) Overall Operation

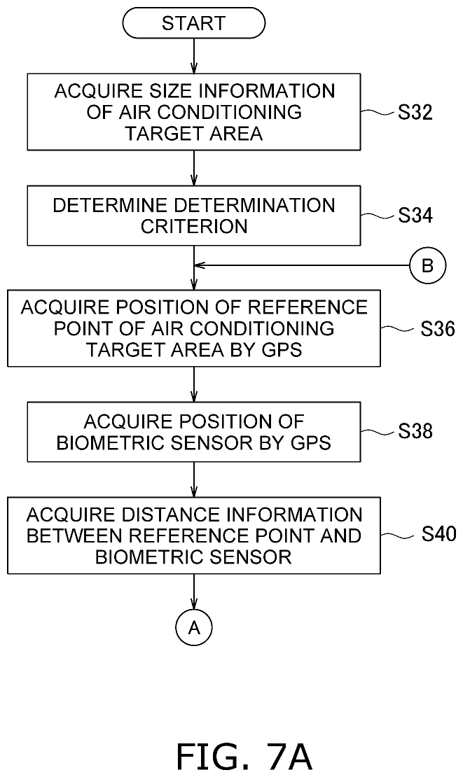

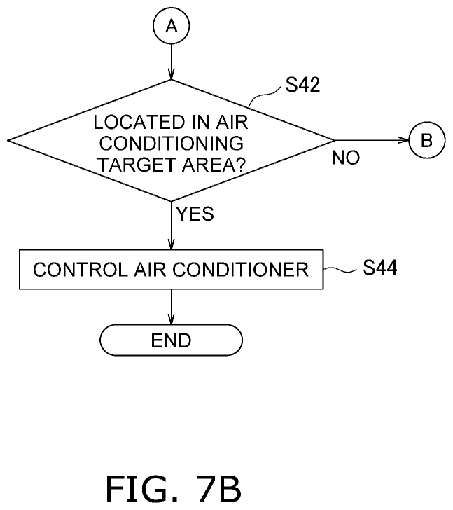

FIGS. 7A and 7B are flowcharts of the control system 200.

First, in step 32, the second acquisition part 18 acquires the information related to the size of the air conditioning target area 101 manually input from the input part 46 of the smartphone 40.

The second determination part 16 determines a determination criterion based on the information related to the size of the air conditioning target area 101 (step S34).

The first acquisition part 12 acquires a position of the reference point of the air conditioning target area 101 by the GPS 42 (step S36). The first acquisition part 12 acquires a position of the smartphone 40 by the GPS 42 (step S38).

The first acquisition part 12 acquires, as the first information, distance information between the reference point of the air conditioning target area 101 and the smartphone 40 based on the information on the position of the reference point of the air conditioning target area 101 and the position of the smartphone 40 (step S40).

Next, in step S42, based on the first information acquired in step S40 and the determination criterion determined in step S34, the first determination part 14 determines whether the smartphone 40 is located in the air conditioning target area 101.

When the first determination part 14 estimates that the smartphone 40 is located in the air conditioning target area 101 (Yes in step S40), the air conditioner is controlled using the detection value of the smartphone 40 (step S42).

When the first determination part 14 estimates that the smartphone 40 is not located in the air conditioning target area 101 (No in step S40), the processing returns to step S36.

(4) Characteristics

(4-1)

In the control system 200 according to the present embodiment, the first acquisition part 12 acquires the position of the reference point of the air conditioning target area 101 and the position of the biometric sensor 40 and thus acquires the distance information between the reference point of the air conditioning target area 101 and the biometric sensor 40 as the first information.

In the control system 200, the position information by the GPS 42 can be used for determining whether to use the detection value of the biometric sensor 40 for controlling the air conditioner 10.

(5) Modifications

(5-1) Modification 2A

The modifications 1A to 1D described in the first embodiment are similarly applied to the control system 200 according to the present embodiment.

(5-2) Modification 2B

The embodiments of the present disclosure have been described above. Various modifications to modes and details should be available without departing from the object and the scope of the present disclosure recited in the claims.

### REFERENCE SIGNS LIST

100, 200: control system
101: air conditioning target area
10: air conditioner
2a, 2b, 2c, 20a, 20b: biometric sensor
20: wearable sensor (biometric sensor)
3a, 3b, 3c: user
20a: first biometric sensor
20b: second biometric sensor
30: remote controller
32, 44: display
34, 46: input part
40: smartphone (biometric sensor)
42: GPS
50: server
52: storage unit
90: network
12: first acquisition part
14: first determination part
16: second determination part
18: second acquisition part

### CITATION LIST

### Patent Literature

Patent Literature 1: Japanese Unexamined Patent Publication No. JP 2017-150702 A

1. A control system that controls an air conditioner that air-conditions an air conditioning target area using a detection value of a biometric sensor worn by a user, the control system comprising:
memory configured to store a control program; and
a processor configured to execute the control program to perform:
a first acquisition that acquires first information related to a distance between a reference point of the air conditioning target area and the biometric sensor;
a first determination that determines whether to use a detection value of the biometric sensor for controlling the air conditioner based on the first information and a determination criterion; and
a second determination that determines the determination criterion.

2. The control system according to claim 1, wherein the first determination determines whether the biometric sensor is located in the air conditioning target area based on the first information and the determination criterion.

3. The control system according to claim 1, wherein the first acquisition acquires radio wave intensity between the air conditioner and the biometric sensor as the first information.

4. The control system according to claim 1, wherein the first acquisition acquires a position of the reference point of the air conditioning target area and a position of the biometric sensor and thus acquires distance information between the reference point of the air conditioning target area and the biometric sensor as the first information.

5. The control system according to claim 1, wherein
the processor further performs a second acquisition that acquires information manually input,
the information manually input includes at least one of information related to a size of the air conditioning target area or information related to the distance from the reference point of the air conditioning target area, and
the second determination determines the determination criterion based on the information from the second acquisition.

6. The control system according to claim 1 further comprising an automatic measurement part that automatically measures the size or a shape of the air conditioning target area, wherein the second determination determines the determination criterion based on a measurement result by the automatic measurement part.

7. The control system according to claim 1, wherein upon determination of whether to use detection values of biometric sensors worn by a plurality of users for controlling the air conditioner, the first determination determines that the detection values of the biometric sensors is not used for controlling the air conditioner when positions of the biometric sensors are changed from an inside of the air conditioning target area to an outside of the air conditioning target area.

8. The control system according to claim 7, wherein after the positions of all the biometric sensors connected to the air conditioner are changed from an inside of the air conditioning target area to an outside of the air conditioning target area, operation of the air conditioner is stopped or suppressed.

9. The control system according to claim 3, wherein the air conditioner and the biometric sensor keep connected to each other when the position of the biometric sensor is changed from an inside of the air conditioning target area to an outside of the air conditioning target area.

10. The control system according to claim 1, when the detection value of the biometric sensor is used in the air conditioning target area, control of the air conditioner is changed in accordance with the distance.

11. The control system according to claim 2, wherein the first acquisition acquires radio wave intensity between the air conditioner and the biometric sensor as the first information.

12. The control system according to claim 2, wherein the first acquisition acquires a position of the reference point of the air conditioning target area and a position of the biometric sensor and thus acquires distance information between the reference point of the air conditioning target area and the biometric sensor as the first information.
